(19) United States
(12) Patent Application Publication
(10) Pub. No.: US 2003/0076696 A1
(43) Pub. Date: Apr. 24, 2003

(54) Device of uninterruptible power supply

(75) Inventor: Wen Inne Tsai, Tainan (TW)

Correspondence Address: Haverstock & Owens LLP, 162 North Wolfe Road, Sunnyvale, CA, 94086, US

(73) Assignee: Delta Electronics, Inc.

(21) Appl. No.: 10/202,549

(22) Filed: Jul. 23, 2002

(30) Foreign Application Priority Data
Oct. 18, 2001 (TW) 090125837

(51) Int. Cl. H02M 5/458

(52) U.S. Cl. 363/37

(57) ABSTRACT

The present invention relates to a three-phase uninterruptible power supply for receiving an input alternating current (AC) voltage and providing an output AC voltage. The three-phase uninterruptible power supply includes a rectifying circuit for receiving the input AC voltage and outputting a direct current (DC) voltage, an inverter for receiving the DC voltage and outputting the output AC voltage, a couple of capacitors respectively electrically connected with the rectifying circuit and the inverter via a first bus and a second bus, and a neutral ground electrically connected to the couple of capacitors to link the DC voltage and the output AC voltage for grounding.

### FIELD OF THE INVENTION

The present invention is related to a device of an uninterruptible power supply and more particularly, to a device of a three-phase uninterruptible power supply.

### BACKGROUND OF THE INVENTION

Please refer to FIG. 1. FIG. 1 illustrates a three-phase uninterruptible power supply of the prior art. Typically, the three-phase uninterruptible power supply includes a filter 10, a rectifying circuit 11, an inverter 12, a couple of capacitors 13, 14, a transformer 15 and a neutral ground 16.

In general, the typical three-phase uninterruptible power supply employs the filter 10 to filter an input three-phase voltage. The power factor of the input three-phase voltage is also very poor because of the harmonic contents in the line current so that the efficiency of transformation is quite limited and it would induce the pollution of the harmonic wave in the utility system. Standards for harmonics and the remedies for a poor line-current waveform and the input power factor are important concerns of the uninterruptible power supply.

Furthermore, the transformer of the typical uninterruptible power supply is huge and heavy. Its cost is very expensive. On the other hand, almost of the present transformers are designed in low frequency and it would reduce the efficiency of transformation.

In addition, the number of the storage batteries used in an uninterruptible power supply has to operate in coordination with the rectifying input voltage. This kind of designs would need more storage batteries for storing the electric power or supplying the rectifying circuit.

Therefore, it is tried to rectify this drawback by the present applicant.

### SUMMARY OF THE INVENTION

It is therefore an objective of the present invention to provide a device of a three-phase uninterruptible power supply for reducing the harmonic contents in the line current.

It is therefore a second objective of the present invention to provide a device of a three-phase uninterruptible power supply for improving the input power factor.

It is therefore a third primary objective of the present invention to provide a three-phase uninterruptible power supply for improving the output efficiency of transformation.

According to the present invention, it provides a device of an uninterruptible power supply for receiving an input alternating current (AC) voltage and providing an output AC voltage. The uninterruptible power supply includes a rectifying circuit for receiving the input AC voltage and outputting a direct current (DC) voltage, an inverter for receiving the DC voltage and outputting the output AC voltage, a couple of capacitors respectively electrically connected with the rectifying circuit and the inverter via a first bus and a second bus, and a neutral ground electrically connected to a node of the connection between the couple of capacitors to link the DC voltage and the output AC voltage for grounding.

Certainly, the device further can include a front stage circuit electrically connected with the rectifying circuit for providing the input AC voltage.

Certainly, the front stage circuit can be a three-phase and four-wire AC circuit.

Certainly, the front stage circuit can further include a switching element for switching the input AC voltage between states of conductance and non-conductance.

Certainly, the device can further include an auxiliary circuit electrically connected with the front stage circuit.

Preferably, the auxiliary circuit includes a battery charger and a storage battery and is electrically connected to the front stage circuit via the switching element.

Preferably, the device further includes a rear stage circuit electrically connected with the inverter for providing the output AC voltage.

Certainly, the rear stage circuit can be a three-phase AC circuit.

Preferably, the rectifying circuit includes plural switches respectively including power elements and diodes for switching the input AC voltage between states of conductance and non-conductance.

Certainly, each of the power elements can be one selected from a group consisting of an insulated gate bipolar transistor, a MOSFET and an intelligent power module (IPM).

Preferably, the inverter includes plural switches respectively including power elements and diodes for switching the input AC voltage between states of conductance and non-conductance.

Preferably, the device further includes a set-up circuit electrically connected between the neutral ground and the storage battery for storing an electric power in the storage battery, wherein the electric power of the storage battery is exchanged into the DC voltage while the input AC voltage is switched off, so as to be exchanged into the output AC voltage.

Certainly, the DC voltage and the output AC voltage can be electrically linked to the neutral ground at a same potential.

The foregoing and other features and advantages of the present invention will be more clearly understood through the following descriptions with reference to the drawings, wherein:

### BRIEF DESCRIPTION OF THE DRAWING

FIG. 1 illustrates an uninterruptible power supply of the prior art;

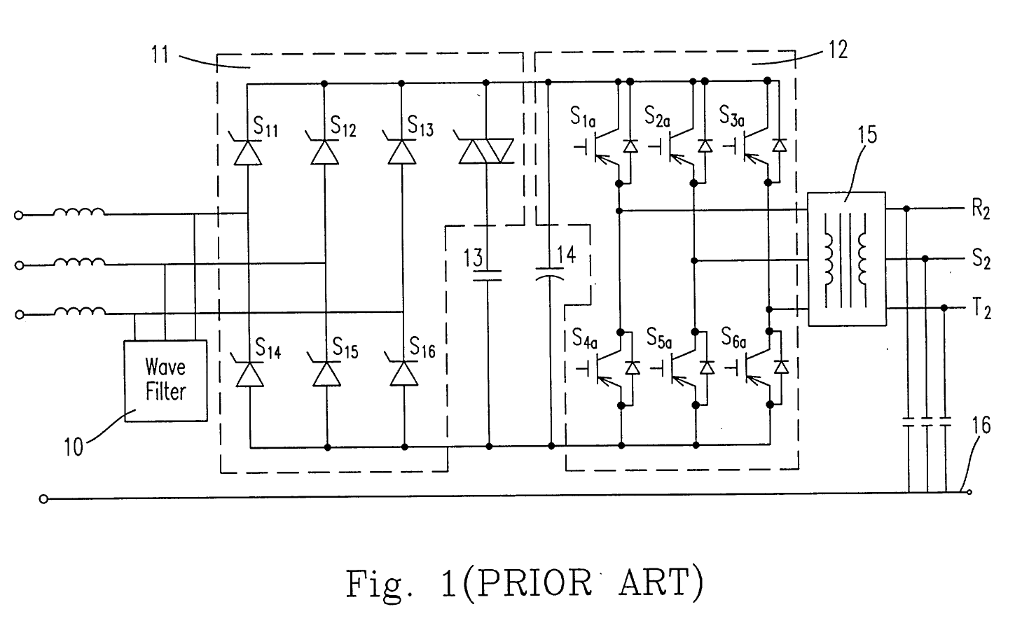

FIG. 2 illustrates a preferred embodiment of the present invention of an uninterruptible power supply;

FIG. 3 illustrates a second preferred embodiment of the present invention of an uninterruptible power supply;

FIG. 4 illustrates a third preferred embodiment of the present invention of an uninterruptible power supply; and

FIG. 5 illustrates a fourth preferred embodiment of the present invention of an uninterruptible power supply.

### DETAILED DESCRIPTION OF THE PREFERRED EMBODIMENTS

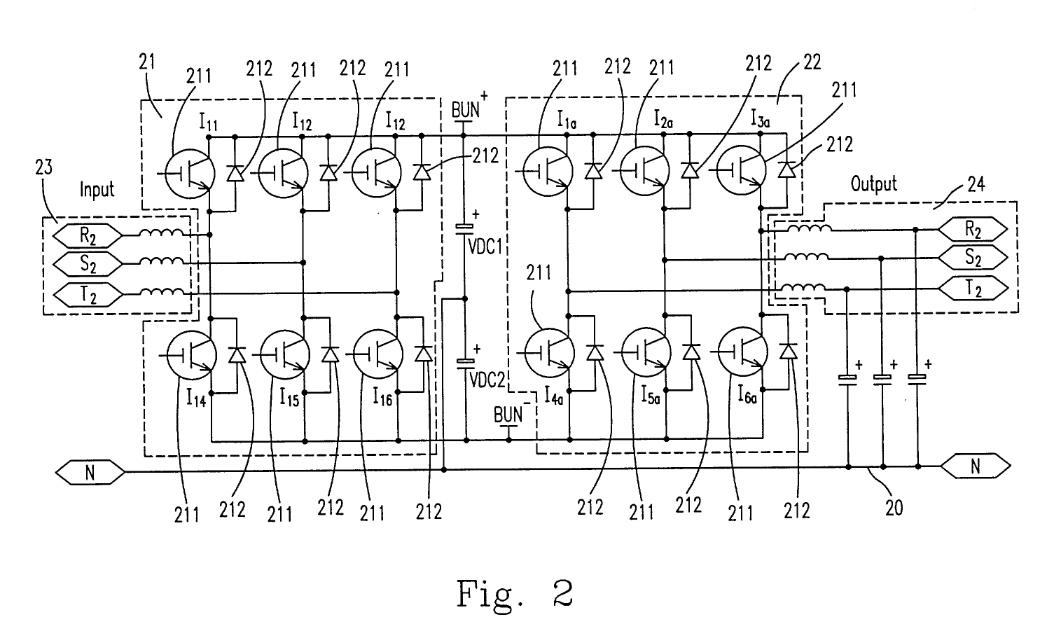

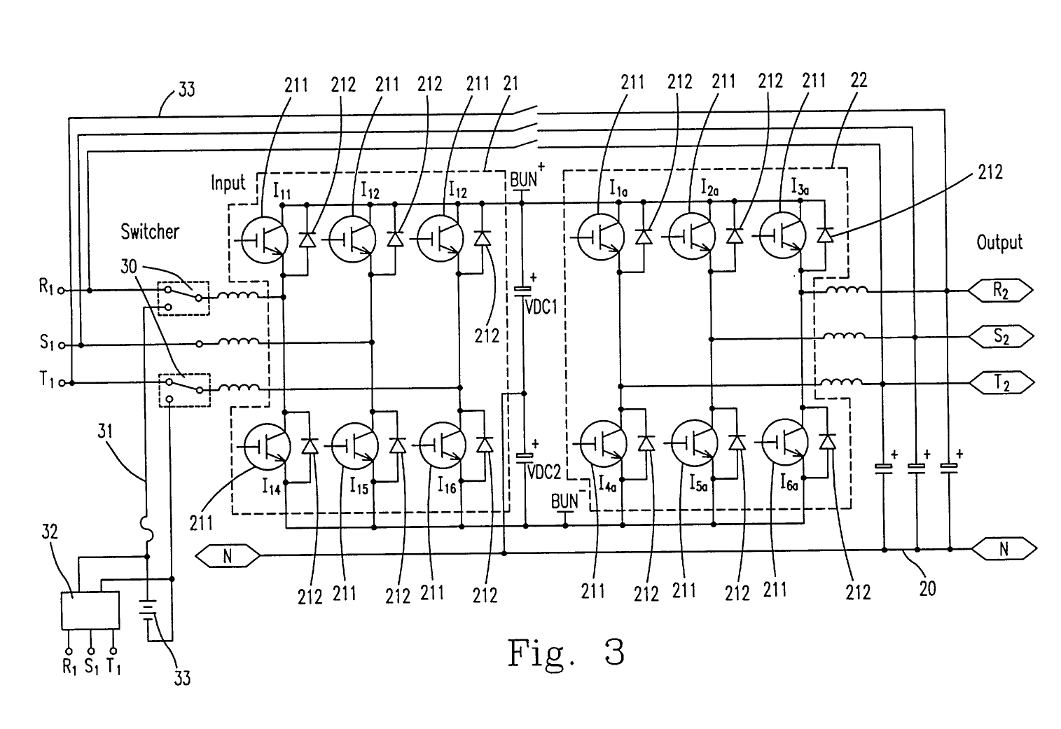

Please refer to FIG. 2. It illustrates a preferred embodiment of the present invention of an uninterruptible power supply. The uninterruptible power supply for receiving an input alternating current (AC) voltage and providing an output AC voltage includes a rectifying circuit 21 for receiving the input AC voltage and outputting a direct current (DC) voltage, an inverter 22 for receiving the DC voltage and outputting the output AC voltage, a couple of capacitors VDC1, VDC2 respectively electrically connected with the rectifying circuit 21 and the inverter 22 via a first bus BUN+ and a second bus BUN−, and a neutral ground 20 electrically connected to the node of the connection between the couple of capacitors VDC1, VDC2 to link the DC voltage and the output AC voltage for grounding. According to the present invention, the uninterruptible power supply further includes a front stage circuit 23 electrically connected with the rectifying circuit 21 for providing the input AC voltage. Meanwhile the front stage circuit 23 is a three-phase and four-wire AC circuit and further includes a switching element 30 for switching the input AC voltage between states of conductance and non-conductance, shown in FIG. 3.

When an input three-phase voltage is inputted via the front stage circuit 23 into the rectifying circuit 21, the switching elements I11-I16 included in the rectifying circuit 21 will transform the input three-phase voltage into a DC voltage. The transformed DC voltage passes through the couple of capacitors VDC1, VDC2 and is transformed into an output AC voltage via the inverter 22. Finally, the output AC voltage is outputted via a rear stage circuit 24.

In addition, shown in FIG. 2, the rectifying circuit 21 further includes plural switches I11-I16 and the inverter 22 includes plural switches I1a-I6a, too. However, each of the plural switches is a high power transforming element instead of a conventional switch. And each of the plural switches respectively includes a power element 211 and a diode 212 for switching the input AC voltage between states of conductance and non-conductance, wherein the power element 211 is composed of an insulated gate bipolar transistor (IGBT). Certainly, the high power-transforming element is composed of not only an IGBT but also by a power MOSFET or an intelligent power module (IPM). This kind of switches composed of an IGBT which is combined advantages of a MOSFET and a bipolar transistor can be operated in high speed and satisfy the requirements of high-voltage-endurance and high-capacity. Therefore, the present invention provides an interrupted power supply having advantages of lightweights, high efficiency and low noise.

FIG. 3 illustrates a second preferred embodiment of the present invention of an uninterruptible power supply. The device of an uninterruptible power supply further includes an auxiliary circuit 31 electrically connected with the front stage circuit 23. The auxiliary circuit 31 includes a battery charger 32 and a storage battery 33 and is electrically connected to the front stage circuit 23. When the utility power supply in a normal condition, the input three-phase voltage charges the storage battery 33 via the battery charger 32. When the utility power supply in an abnormal condition, the input three-phase voltage is turned off and the auxiliary circuit 31 becomes a discharge circuit. The electric power of the storage battery is exchanged into the DC voltage by means of conducting via the switcher 30 of the front stage circuit 23, so as to be exchanged into the output AC voltage. On the other hand, the uninterruptible power supply can be electrically connected with a bypass loop 34 for being overhauled.

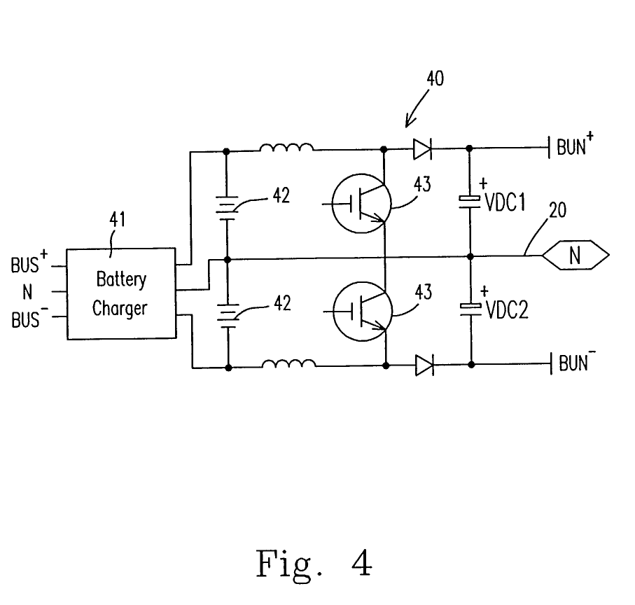

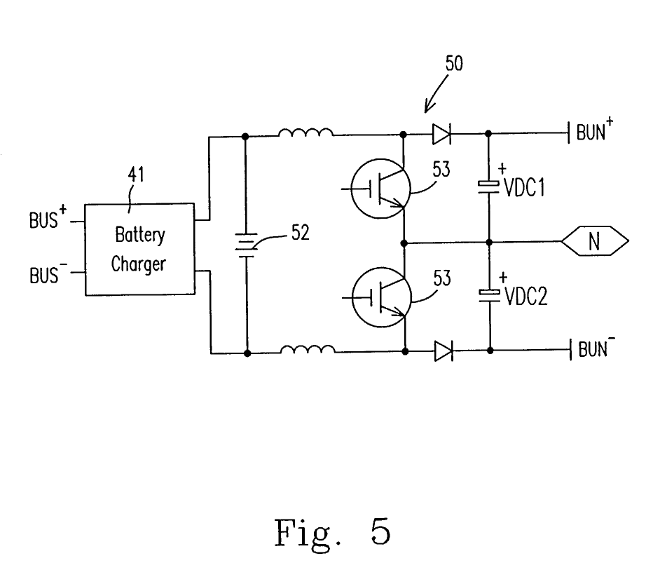

FIGS. 4 and 5 respectively illustrate a third and a fourth preferred embodiments of the present invention of an uninterruptible power supplies. The uninterruptible power supply further includes a set-up circuit 40, 50 disposed between the first bus BUN+ and the second bus BUN− and electrically connected with the neutral ground 20 for reducing the number of the storage batteries used in an uninterruptible power supply. The set-up circuits 40, 50 respectively include a battery charger 41, storage batteries 42, 52 and high-efficiency switching elements 43, 53. In FIG. 4, the storage battery 42 is a device in series connection. The neutral ground 20 is electrically connected with the battery charger 41 first, then electrically connected with the storage battery 42 at the same potential. In FIG. 5, the storage battery 42 is a single device. The neutral ground 20 is electrically connected between the high-efficiency switching element 53 and the couple of capacitors VDC1, VDC2.

Accordingly, the present invention provides a device of a three-phase uninterruptible power supply for reducing the harmonic wave of the input voltage, improving the power factor of the input voltage and the output efficiency of transformation. It is really a useful invention.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A device of an uninterruptible power supply for receiving an input alternating current (AC) voltage and providing an output AC voltage, comprising:
a rectifying circuit for receiving said input AC voltage and outputting a direct current (DC) voltage;
an inverter for receiving said DC voltage and outputting said output AC voltage;
a couple of capacitors respectively electrically connected with said rectifying circuit and said inverter via a first bus and a second bus; and
a neutral ground electrically connected to a node of the connection between said couple of capacitors to link said DC voltage and said output AC voltage for grounding.

2. The device according to claim 1 further comprising a front stage circuit electrically connected with said rectifying circuit for providing said input AC voltage.

3. The device according to claim 2 wherein said front stage circuit is a three-phase and four-wire AC circuit.

4. The device according to claim 2 wherein said front stage circuit further comprises a switching element for switching said input AC voltage between states of conductance and non-conductance.

5. The structure according to claim 4 further comprising an auxiliary circuit electrically connected with said front stage circuit.

6. The device according to claim 5 wherein said auxiliary circuit comprises a battery charger and a storage battery and is electrically connected to said front stage circuit via said switching element.

7. The device according to claim 1 further comprising a rear stage circuit electrically connected with said inverter for providing said output AC voltage.

8. The device according to claim 7 wherein said rear stage circuit is a three-phase AC circuit.

9. The device according to claim 1 wherein said rectifying circuit comprises plural switches respectively including power elements and diodes for switching said input AC voltage between states of conductance and non-conductance.

10. The device according to claim 9 wherein each of said power elements is one selected from a group consisting of an insulated gate bipolar transistor, a MOSFET and an intelligent power module (IPM).

11. The device according to claim 1 wherein said inverter comprises plural switches respectively including power elements and diodes for switching said input AC voltage between states of conductance and non-conductance.

12. The device according to claim 11 wherein said power elements is one selected from a group consisting of an insulated gate bipolar transistor, a MOSFET and an intelligent power module (IPM).

13. The device according to claim 6 further comprising a set-up circuit electrically connected between said neutral ground and said storage battery for storing an electric power in said storage battery, wherein said electric power of said storage battery is exchanged into said DC voltage while said input AC voltage is switched off, so as to be exchanged into said output AC voltage.

14. The device according to claim 1 wherein said DC voltage and said output AC voltage are electrically linked to said neutral ground at a same potential.
